(19) United States
(12) Patent Application Publication
(10) Pub. No.: US 2013/0302499 A1
(43) Pub. Date: Nov. 14, 2013

(54) METHOD FOR PRODUCING AERATED FOOD PRODUCTS

(71) Applicants: Casper Lund, Beder (DK); Geoffrey O'Sullivan, Tadworth Surrey (GB); Henrik Aabye Jensen, Gedved (DK); Henrik Kragh, Brabrand (DK); Susanne Budde Lund, Randers NO (DK); Finn Madsen, Abyhoj (DK)

(72) Inventors: Casper Lund, Beder (DK); Geoffrey O'Sullivan, Tadworth Surrey (GB); Henrik Aabye Jensen, Gedved (DK); Henrik Kragh, Brabrand (DK); Susanne Budde Lund, Randers NO (DK); Finn Madsen, Abyhoj (DK)

(73) Assignee: DUPONT NUTRITION BIOSCIENCES APS, Copenhagen K (DK)

(21) Appl. No.: 13/997,315

(22) PCT Filed: Jan. 31, 2012
(86) PCT No.: PCT/EP2012/051588

§ 371 Date: Jun. 24, 2013

Related U.S. Application Data
(60) Provisional application No. 61/438,439, filed on Feb. 1, 2011.

(30) Foreign Application Priority Data
Feb. 1, 2011 (EP) 11152913.7

(51) Int. Cl. A23G 3/52

(52) U.S. Cl. CPC A23G 3/52
USPC 426/571

(57) ABSTRACT

The present invention relates to aerated food products and a method for their preparation. In particular, the present invention relates to improved aerated confectionery such as marshmallows and marbits and methods of their preparation.

### CROSS REFERENCE TO RELATED APPLICATION

This application claims the benefit of PCT Patent Application No. PCT/EP2012/051588, filed on Jan. 31, 2012, in the World Intellectual Property Office, the disclosure of which is incorporated herein by reference.

### FIELD OF THE INVENTION

The present invention relates to aerated food products such as confectionary products and a method for their preparation. In particular, the present invention relates to improved aerated confectionery such as marshmallows and marbits and methods of their preparation.

### BACKGROUND OF THE INVENTION

Aerated products such as aerated confectionery are very popular foodstuffs. An example of aerated confectionery is marshmallows. Marshmallows exist in different formats. The basic composition of marshmallows comprises water, a disaccharide such as sucrose, a monosaccharide such as dextrose, a syrup such as corn syrup, and a stabiliser such as gelatine. It is also possible to incorporate flavours and colouring agents into this basic composition.

While there are many types of marshmallow on the market, their methods of preparation generally fall into two main processes: extruded marshmallow and deposited marshmallow. In both types, a sugar syrup and a gelling agent such as gelatine are the two main ingredients. Typically, the sugar syrup is heated to reduce moisture and is thereafter cooled down, and then combined with the gelatine solution to form slurry. That slurry is then aerated to form foam, and after aeration, colours and flavours are then added to the foam.

The particular marshmallow product may be formed into its final shape by an extrusion process. That is, after aeration, the foam is extruded through a die to form a rope. The die imparts the desired peripheral shape to the extrudate rope. The rope is allowed to rest brie to set, and then is cut into desired sizes. For dried marshmallows, the process can additionally include one or more drying steps.

Methods for preparing candies and confections, especially aerated confections such as marshmallows, often involve the preparation of concentrated sugar syrup. Traditionally, the preparation of sugar syrup involve three separate steps including (1) admixing dry sucrose and corn syrups with water to form slurry, (2) heating to boiling to dissolve the sugars, (3) evaporating moisture to concentrate the syrup to the desired solids concentration. Generally, these steps are performed as separate steps and in batch mode. Batch processing allows for close control over the extent of crystals in the concentrated sugar syrup.

For example, sugar, water and corn syrup are first blended in an agitated kettle to form slurry. Then, the slurry is heated in the kettle with agitation for an extended time to dissolve the sugar to form dilute sugar syrup. Next, the sugar syrup is concentrated such as by flash evaporation in a separate piece of equipment or by boiling for extended times in the kettle to achieve a concentrated sugar syrup of the desired moisture level.

The type and extent of agitation and rate of concentration are carefully controlled to achieve desired levels of sugar crystals in the syrup. The presence or absence of seed crystals or other nuclei such as from further ingredients in the concentrated sugar solution profoundly influences the properties of the finished product such as the texture of a dried marshmallow. As a result, the batches of concentrated sugar syrup have a limited “pot life,” i.e., must be used within a short time (e.g., 15 to 60 minutes).

Marbits are a confectionery product which are dry, crisp and aerated sugar confectionaries that are traditionally used as components in mixed breakfast cereals. They come in all shapes and colours. Traditionally marbits are made by producing a conventional marshmallow mass using a 7 step process that comprises a syrup formation, slurry formation, aeration, extrusion, starch depositing, cutting and drying. This process normally will take between 8-16 hours due to all the process steps and especially the final drying step.

Sugar reduced aerated confections are known from US2009/0081349 which in dried form are suitable for addition as a component in a RTE (ready to eat) cereal.

A method and apparatus for the continuous preparation of a frozen aerated confection such as ice cream is disclosed in WO97/39637.

JP 01095736 discloses a method for making rice cakes.

There is still a need for more simplified means for producing aerated products such as marbits which minimize or eliminates steps in the known processes.

### SUMMARY OF THE INVENTION

In a first aspect the present invention relates to a method for producing an aerated product such as a confectionary product in a continuous process in which ingredients are mixed by use of an extruder with at least one screw-mixer extending in a feed direction through a mixing chamber having at least one port for adding ingredients and optionally at least one inlet for adding pressurized gas, the at least one port and the optionally at least one inlet being arranged successively along the screw-mixer in the feed direction, the method comprising the steps of:

adding dry content ingredient(s) and wet content ingredient(s) to the at least one port,
mixing the dry and wet content ingredient(s) by operation of the extruder to obtain a mixture,
heating the mixture in the extruder,
optionally cooling the heated mixture,
aerating the ingredients by adding a gas to an at least one inlet or by adding ingredients that generates a gas to the at least one port, and
extruding the mixture through a die,
wherein the aerated product comprises moisture in an amount of 0.1 to 15% by weight.

In a further aspect, the invention relates to a method for producing an aerated product such as a confectionary product in a continuous process in which ingredients are mixed by use of an extruder with at least one screw-mixer extending in a feed direction through a mixing chamber having at least one port for adding ingredients and at least one inlet for adding pressurized gas, the at least one port and the at least one inlet being arranged successively along the screw-mixer in the feed direction, the method comprising the steps of:

adding dry content ingredient(s) and wet content ingredient(s) to the at least one port,
mixing the dry and wet content ingredient(s) by operation of the extruder to obtain a mixture,
heating the mixture in the extruder,
optionally cooling the heated mixture,
adding a pressurized gas to the mixture by an at east one inlet, and
extruding the mixture through a die,
wherein the aerated product comprises moisture in an amount of 0.1 to 15% by weight.

### LEGENDS TO THE FIGURE

FIG. 1 is a schematic process flow diagram of a method of preparing an aerated product.

### DETAILED DISCLOSURE OF THE INVENTION

The present invention provides a method for preparing an aerated product such as an aerated confectionery product e.g. marbits, and cereal bars or nutritional snacks.

It has been found by the present inventor(s) that the known methods for preparing aerated products can be improved by the use of an extruder to hydrate, mix, aerate and extrude the ingredients. By the herein disclosed method an aerated product such as marbit rope may be prepared having a moisture content close to the desired moisture content in the final marbits, and thereby avoiding a drying step. Furthermore, the present method is especially suitable using polydextrose, hydrogenated polydextrose or a mixture thereof, for example Litesse® available from Danisco A/S, which apart from the beneficial effect as a bulking agent and as a low-energy ingredient replacing sugar, may also results in an improved texture.

The present method may be performed at a low temperature especially at the last part of the extrusion process which makes it possible to add heat sensitive ingredients such as flavours, colours, vitamins, minerals, cultures etc. which has not previously been possible.

In the herein disclosed method all steps for preparing the aerated product have been incorporated into a one step or continuous process. By “one step” or “continuous” is meant a method in which the ingredients are activated or hydrated, mixed, aerated and extruded in one procedure.

It has surprisingly been found that the herein disclosed method enable some of the ingredients for example for the preparation of marbit rope to be activated at a very low moisture content. By “low” moisture content is meant the use of less liquid than is needed to hydrate the ingredient under normal temperature and pressure conditions. In the known methods saccharide is for example conventionally added as a syrup, whereas it in the present method saccharide may be added as a dry ingredient. The final product may therefore leave the extruder at or close to the desired final moisture content avoiding the use of the otherwise conventional final drying step.

In one aspect, the aerated product is aerated by the injection of gas into the product stream and a final expansion takes place when the product exits the extruder. In another aspect, ingredients generating a gas are added during the extrusion method. The herein described method makes production of an aerated product such as marbits possible which have a desired texture, density and/or moisture content when the product leaves the extruder. The disclosed method may therefore reduce the processing time compared to previous described procedures. The disclosed method may also save costs due to the limited need for heating and evaporating of large amounts of water which is normally used in conventional processes. It is a further advantage that the method may be performed at a low temperature especially at the last part of the extrusion process which makes it possible to add heat sensitive ingredients.

The herein disclosed method is flexible and the final product quality such a density, crispness, moisture and taste can be controlled by process parameters and various ingredients such as hydrocolloids, emulsifiers, fibres, flavours and others.

Disclosed herein is thus a method for producing an aerated product in a continuous process in which ingredients are mixed by use of an extruder with at least one screw-mixer extending in a feed direction through a mixing chamber having at least one port for adding ingredients and optionally at least one inlet for adding pressurized gas, the at least one port and the optionally at least one inlet being arranged successively along the screw-mixer in the feed direction, the method comprising the steps of:

adding dry content ingredient(s) and wet content ingredient(s) to the at east one port,
mixing the dry and wet content ingredient(s) by operation of the extruder to obtain a mixture,
heating the mixture in the extruder,
optionally cooling the heated mixture,
aerating the ingredients by adding a gas to an at least one inlet or by adding ingredients that generates a gas to the at least one port, and
extruding the mixture through a die,
wherein the aerated product comprises moisture in an amount of 0.1 to 15% by weight.

In a further aspect, disclosed herein is a method for producing an aerated product in a continuous process in which ingredients are mixed by use of an extruder with at least one screw-mixer extending in a feed direction through a mixing chamber having at least one port for adding ingredients and at least one inlet for adding pressurized gas, the at least one port and the at least one inlet being arranged successively along the screw-mixer in the feed direction, the method comprising the steps of:

adding dry content ingredient(s) and wet content ingredient(s) to the at least one port,
mixing the dry and wet content ingredient(s) by operation of the extruder to obtain a mixture,
heating the mixture in the extruder,
optionally cooling the heated mixture,
adding a pressurized gas to the mixture by an at least one inlet, and
extruding the mixture through a die such as through a die with one or more openings,
wherein the aerated product comprises moisture in an amount of 0.1 to 15% by weight.

In one aspect, an extruder having at least one screw such as a single or preferably a twin screw extruder can be used to practice in a single piece of equipment the entire process of mixing, heating, aeration and extrusion to obtain an aerated confectionery extrudate. Employment of a single piece of equipment provides a simplified means of practicing the present methods.

### Composition of Aerated Product

By “aerated product” is meant the extrudate product leaving the extruder.

In one aspect, the aerated product is an aerated confectionery product, a cereal bar or a nutritional snack.

By “aerated confectionery product” is meant an aerated confectionery food product such as marshmallow or marbit robe. Typically these products comprise water, a sweetening and/or texturising component, flavours and a gelling agent and optionally colouring agents. In one aspect, a bulking agent is added such as polydextrose, hydrogenated polydextrose or a mixture thereof to replace part of the sweetening component. In one aspect, the aerated confectionery product is marbit rope.

After the aerated product has left the extruder a finishing step of drying, cutting, covering the surface with a material that prevents stickiness or other steps that might change the product may be performed.

In one aspect, the herein disclosed aerated product comprises a gelling agent such as a hydrocolloid, water, at least one sweetening and/or texturising agent such as a saccharide component and at least one bulking agent such as polydextrose.

By “wet content ingredients” means in the present context a liquid such as an aqueous suspension of ingredients or water as such. By “dry content ingredients” means in the present context ingredients which may suitably be added in the form of a powder. Depending on the composition of the product some ingredients may more suitably be added in either dry or wet form.

In one aspect, the amount of moisture in the wet content ingredient(s) is adjusted such that the final moisture content of the aerated product leaving the extruder is close to or at the desired moisture content in the final aerated product. The moisture in the aerated confectionary products is suitably in the form of water present in the other ingredients. An example of ingredients which may be added together with water is a bulking agent or gelling agent. Water may also be added as water as such. In one aspect, the amount of moisture added to the extruder is at the most 15%, 12%, 10%, 8%, 7%, 6%, 5%, 4%, or 3% by weight of the total amount of added ingredients. In a further aspect, the amount of moisture added to the extruder is at least 0.1%, 0.2%, 0.4%, 0.5%, 0.6%, 0.8%, 1.0%, 1.2%, 1.4%, 1.6%, 1.7%, 1.8% 2.0%, 2.2%, 2.4%, 2.6% or 3.0% by weight of the total amount of added ingredients.

In one aspect, the amount of moisture in the wet content ingredient(s) is adjusted such that the moisture content in the aerated product is 0.1 to 15%, 0.5 to 15%, 0.5 to 10%, 1 to 8%, 1 to 6%, 1 to 4% or 1 to 3% by weight final moisture content. In a further aspect, the amount of moisture in the wet content ingredient(s) is adjusted such that the moisture content in the aerated product is 0.1 to 15%, 0.5 to 15%, 0.5 to 10%, 0.8 to 8%, 1.0 to 6%, 1.2 to 5%, 1.3 to 5%, 1.4-4.5% or 1.5 to 4% by weight final moisture content. In a further aspect, the amount of moisture in the wet content ingredient(s) is adjusted such that the moisture content in the aerated product is at the most 15%, 12%, 10%, 8%, 7%, 6%, 5%, 4%, or 3% by weight final moisture content. In a further aspect, the amount of wet content ingredient(s) is adjusted such that the moisture content in the aerated product is at least 0.1%, 0.2%, 0.4%, 0.6%, 0.8%, 1.0%, 1.2%, 1.4%, 1.6%, 1.7%, 1.8%, 2.0%, 2.2%, 2.4%, 2.6%, 2.8% or 3.0% by weight final moisture content. The final moisture content may be measured using conventional techniques known to one skilled in the art such as for example by measuring the moisture content in the extrudate after cooling in a Sartorius MA 30 moisture analyser (Sartorius, Goettingen, Germany) or according to A.O.A.C. Method 968.11. In one aspect, the moisture content is kept in the range of 2 to 4% by weight.

In one aspect, the process is a closed process where there is no evaporation of moisture such as water and the amount of water added either as such or together with other wet content ingredient(s) is the same amount as in the final product. In a further aspect, the process is an open process where there is some evaporation of water during the process for example through a venting port where water, for example in the form of steam, could escape or be drawn out.

In one aspect, the density of the aerated product leaving the extruder is in the range of from about 0.10 to about 1.0 g/cc, such as 0.2-0.9 g/cc or 0.3-0.8 g/cc.

In one aspect, the wet content ingredient(s) is an aqueous liquid such as water optionally having ingredients suspended therein which suitably are added in the form of a liquid. In a further aspect, the wet content ingredient(s) comprises a gelling agent such as a hydrocolloid ingredient. In a further aspect, the wet content ingredient(s) is water mixed with for example the gelling agent or other ingredients which are suitably added as a liquid such as an aqueous liquid.

In one aspect, the ratio of gelling agent:aqueous liquid such as water is between 1:10 to 1.2, 1:10 to 1:5, 1:1.5 to 1.5:1, more preferably between 1:1.3 to 1.3:1, more preferably between 1:1.2 to 1.2:1, and more preferably between 1:1.1 to 1.1:1, and most preferably about 1:1.

The term “gelling agent” designates a substance which is used to pass from a solution to a solid state. Examples of suitable gelling agents include such agents as whipping agents (e.g., based on soy proteins, albumen, sodium caseinate, whey protein, malted milk, and mixtures thereof), and hydrocolloids such as described above for example pectin, carrageenan, alginate, CMC, MCC, gelatine, modified starches, gums and mixtures thereof.

The herein disclosed aerated product may include 0.05 to 30%, such as 0.1 to 10% or 0.1 to 5 by weight of a gelling agent.

In one aspect, the aerated confectionery product may comprise a gelling agent in the form of hydrocolloids. In one aspect, examples of hydrocolloid ingredient(s) is gelatine, pectin, carrageenan, alginate, CMC, MCC, modified starches, albumen, gums and/or mixtures thereof The hydrocolloids may be added to modify product texture during processing or in the final product or to improve product stability during processing or in the final product. The hydrocolloids used herein may be ionic as well as non-ionic and include both gelling or non-gelling hydrocolloids. Examples are, but not limited to, gelatine, high ester pectins, low ester pectins, low ester amidated pectins, carrageenan, agar, alginate, gellan gum, xanthan, CMC, guar gum, locust bean gum, tara gum, konjac gum and starch. Certain hydrocolloids may be added due their surface activity to stabilise the foam created. Examples are, but not limited to, gum arabic, sugar beet pectin, locust bean gum, gelatine, MC, HPMC and/or hydrophobically modified starch.

In one aspect, the gelling agent is gelatine, or a combination of gelatine and other hydrocolloids such as pectin. The gelatine can be derived from bovine, porcine, or piscine (fish) sources or can be mixtures thereof.

In another aspect, the aerated confectionery product may comprise an emulsifier. The emulsifiers used herein are here defined as polar components ranging from very low to very high polarity. The polar components include ionic and non-ionic types. Examples are, but not limited to, polar lipids such as monoglycerides, mono-diglycerides, acetic acid ester of mono-diglycerides, lactic acid ester of mono-diglycerides, citric acid ester of mono-diglycerides, mono- and di-acetyl tartaric acid esters of mono-diglycerides, sucrose esters of fatty acids, polyglycerol esters of fatty acids, fatty acids, sorbitan esters, and/or sucroglycerider.

The group of emulsifiers excluding fatty acids, sorbitan esters, sucroglycerider and lecithin can be described by the following formula (I), where at least one of R1, R2 and R3 has a lipophilic acyl group which can be branched and at least one of R1, R2 and R3 is either H or an acid such as citric acid, lactic acid, acetic acid, acetylated tartaric acid. T is an integer of at least 1.

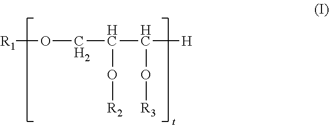

In another aspect, the aerated confectionery product may comprise a mixture of emulsifiers, as defined above, hydrocolloids as defined above and gelling agents.

The present aerated product may also further comprise a salt, in particular chosen from the group consisting of: sodium chloride, potassium chloride, sodium glutamate, and mixtures thereof.

The present aerated product may also comprise about 0.01% to about 25% by weight of a fortifying ingredient in dry particulate form. The nutritional fortifying ingredient can be selected from the group consisting of biologically active components, fiber, micronutrients, minerals, and mixtures thereof. Suitable biologically active components can comprise nutraceuticals, medicinal herbs (e.g., St. John's wort, rose hips), therapeutic or ethical drugs such as prescription drugs, and mixtures thereof. Nutraceuticals can include both heat-sensitive (such as soy isoflavones and certain botanicals) and heat tolerant materials (e.g., ribosome, chromium picolinate). Fiber can include both soluble and insoluble and mixtures thereof. Preferred micronutrients are selected from the group consisting of vitamins, trace elements (e.g., selenium, chromium, copper, manganese, iron, zinc) and mixtures thereof. Preferred minerals include calcium, phosphorus (e.g., from phosphates), magnesium and mixtures thereof. Minerals and trace elements differ in concentration with trace elements typically being measured in ppb. The skilled artisan will also appreciate that some materials can have multiple functionality.

The nutritional fortifying ingredient may be added in dry form as part of the “dry content ingredient(s)” such as for example in form of a fine powder having a particle size such that 90% has a particle size of less than 150 micron or less in size.

In one aspect, the aerated product may, if appropriate, comprise vitamins, minerals, cultures, enzymes, antioxidants, phytosterols.

In another aspect, the aerated product may further comprise a savoury flavour, said savoury flavour being in particular chosen from the group consisting of: cheese, fish, vegetables, herbs, spices, meat and salting flavours, such as emmental, chilli, salmon, bacon, tomato, rosemary, and mixtures thereof.

In another aspect, the aerated product may also, if appropriate, comprise a colouring agent.

In another aspect, some of the ingredients in the aerated product are heat sensitive ingredients. This types of ingredients are as described below preferably added at a step in the process disclosed herein where the temperature is low.

In one aspect, the dry content ingredient(s) comprises at least one sweetening agent. In a further aspect, the sweetening agent comprises a saccharide component.

In a further aspect, the dry content ingredient(s) comprises at least one bulking agent.

In a further aspect, the dry content ingredients are a combination of a saccharide component such as sucrose and glucose powder and/or a bulking agent such as polydextrose, hydrogenated polydextrose or mixtures thereof and optionally further dry content ingredients.

In one aspect, the aerated confectionery product prepared by the herein disclosed process comprises 25 to 98% by weight of a saccharide component. In a further aspect, the saccharide component is used in an amount of 50% to 98%, such as 70% to 98%, such as 70% to 90% by weight of the confectionery product. In a further aspect, the saccharide component is used in an amount of at least 25%, 30%, 35%, 40%, 45%, 50%, 55%, 60%, 65%, 70%, 75%, 80%, 85%, 90%, 95%, 96%, 97% or 98% by weight of the confectionery product. In a further aspect, the saccharide component is used in an amount of at the most 98%, 97%, 96%, 95%, 94%, 93%, 92%, 91% or 90% by weight of the confectionery product.

In one aspect, the saccharide component is in the form of a powder which can include pure monosaccharide dextrose (e.g., anhydrous, monohydrate or dextrose powder) and disaccharide sugars such as sucrose, and fructose, as well as hydrolysed starch powders such as corn syrup powder which include dextrin, maltose and dextrose, invert sugar powders which include fructose and dextrose and/or converted fructose or glucose syrup powder. A portion of the saccharide component may be supplied by impure or flavoured saccharidic ingredients such as dried fruit juices, purees, honey nectars, concentrated fruit juices, fruit flavours and mixtures thereof.

In a further aspect, the sweetening agent includes sucrose, dextrose, glucose syrup powder, corn syrup solids, fructose, dried honey, and mixtures thereof.

In a further aspect, the saccharide component comprises sucrose such as sucrose powder. In yet a further aspect, the saccharide component comprises glucose syrup such as glucose syrup powder. In a further aspect, the saccharide component is a mixture of sucrose and glucose syrup powder.

In one aspect, the aerated product comprises 50% to 98% by weight of saccharide such as 70% to 90% by weight of the aerated product.

In one aspect, the aerated product comprises 50% to 98% by weight of saccharide such as 65% to 80% by weight of sucrose and/or 15% to 30% by weight of glucose powder based on the total weight of the aerated product.

In one aspect, the aerated product comprises 15% to 75% by weight such as 15% to 60% by weight or 20% to 50% by weight polydextrose based on the total weight of the aerated product.

In one aspect, the aerated product comprises 65% to 80% by weight of sucrose such as 70% to 80% by weight of sucrose based on the total weight of the aerated product.

In one aspect, the aerated product comprises 15% to 30% by weight of glucose powder such as 20% to 30% by weight of glucose powder based on the total weight of the aerated product.

In another aspect, the aerated product comprises 50% to 98% by weight of saccharide such as 65% to 80% by weight of sucrose and/or 15% to 30% by weight of glucose powder, and 15% to 75% by weight polydextrose based on the total weight of the aerated product.

In one aspect, for the production of dried marbits, for example, the saccharide component is sucrose. In a further aspect, for the production of dried marbits, for example, the saccharide component is a glucose powder and/or sucrose.

An optional ingredient is a bulking agent. The term “bulking agent” designates non-nutritive or nutritive substances added to foods to increase the bulk and effecting or non-effecting satiety, which are especially used in foods designed for weight management.

In one aspect, the bulking agent is essentially non-sweetening and/or low sweetening. Fractions of standard sweeteners (sweetening power equal to sucrose/saccharose) can be used. It should be mentioned here the following relative sweetness: sucrose/saccharose=1, xylitol=1, maltitol=0.9, lactitol=0.4, and polydextrose 0.1.

Preferably, the bulking agent is a sucrose and/or corn syrup substitute, in particular chosen from the group consisting of polyols and fibers.

Polyols are sugar-free sweeteners, also called sugar alcohols because part of their structure chemically resembles sugar and part is similar to alcohols. Other terms used are polyhydric alcohols and polyalcohols. Examples are erythritol, hydrogenated starch hydrolysates (including maltitol syrups), isomalt, lactitol, maltitol, mannitol, sorbitol and xylitol. The term “polyol” means hexitols such as sorbitol and mannitol, and pentitols such as xylitol.

The term also includes C4-polyhydric alcohols such as erythritol or C12-polyhydric alcohols such as lactitol or maltitol. The term polyol composition means a composition of two or more polyols. Such compositions preferably differ markedly from compositions arising in the industrial preparation of polyols such as sorbitol. Preferred are those compositions which comprise at least two polyols having a different number of C atoms, in particular the term means a composition comprising at least one hexitol and at least one pentitol.

Among the polyols, xylitol, maltitol, lactitol, and mixtures thereof are preferably used.

In one aspect, the fiber is selected from the group consisting of: polydextrose, inuline, and mixtures thereof. In a further aspect, the fiber is polydextrose.

Polydextrose is a polysaccharide synthesised by random polymerisation of glucose, sorbitol and a suitable acid catalyst at high temperature and partial vacuum. The term “polydextrose” is defined in greater detail below. Polydextrose is widely used in various kinds of food products as a bulking agent and as a low-energy ingredient, replacing sugar and partially fat. Polydextrose is not digested or absorbed in the small intestine and a large portion is excreted in the feces. The term “polydextrose” as used herein is a low calorie polymer of glucose that is resistant to digestion by the enzymes in the stomach. It includes polymer products of glucose which are prepared from glucose, maltose, oligomers of glucose or hydrolyzates of starch, or starch which are polymerized by heat treatment in a polycondensation reaction in the presence of an acid e.g. Lewis acid, inorganic or organic acid, including monocarboxylic acid, dicarboxylic acid and polycarboxylic acid, such as, but not limited to the products prepared by the processes described in the following U.S. Pat. Nos. 2,436,967, 2,719,179, 4,965,354, 3,766,165, 5,051,500, 5,424,418, 5,378,491, 5,645,647 or 5,773,604, the contents of all of which are herein incorporated by reference.

The term polydextrose also includes those polymer products of glucose prepared by the polycondensation of glucose, maltose, oligomers of glucose or starch hydrolyzates described hereinabove in the presence of a sugar alcohol, e.g., polyol, such as in the reactions described in U.S. Pat. No. 3,766,165. Moreover, the term polydextrose includes the glucose polymers, which have been purified by techniques described in the art, including any and all of the following but not limited to (a) neutralization of any acid associated therewith by base addition thereto, or by passing a concentrated aqueous solution of the polydextrose through an adsorbent resin, a weakly basic ion exchange resin, a type II strongly basic ion-exchange resin, mixed bed resin comprising a basic ion exchange resin, or a cation exchange resin, as described in U.S. Pat. Nos. 5,667,593 and 5,645,647, the contents of both of which are incorporated by reference; or (b) decolorizing by contacting the polydextrose with activated carbon or charcoal, by slurrying or by passing the solution through a bed of solid adsorbent or by bleaching with sodium chlorite, hydrogen peroxide and the like; (c) molecular sieving methods, like UF, RO (reverse osmosis), size exclusion, and the like; (d) or enzymatically treated polydextrose or (e) any other art recognized techniques known in the art. Moreover, the term polydextrose includes hydrogenated polydextrose which, as used herein, includes hydrogenated or reduced polyglucose products prepared by techniques known to one of ordinary skill in the art. Some of the techniques are described in U.S. Pat. Nos. 5,601,863, 5,620,871 and 5,424,418, the contents of which are incorporated by reference. It is preferred that the polydextrose used is substantially pure. It may be made substantially pure using conventional techniques known to one skilled in the art, such as chromatography, including column chromatography, HPLC, and the like. It is more preferred that the polydextrose used is at least 80% pure, i.e. at least about 80% of the impurities are removed. More preferably it is at least 85% pure or even more preferably it is at least 90% pure.

An example of polydextrose is Litesse® from Danisco.

Another optional ingredient is a high intensity sweetener such as stevia, aspartame, sucralose, neotame, acesulfame potassium, and saccharin. These sugar substitutes are especially useful in an aerated product in which a high percentage of a bulking agent is used.

In one aspect, the aerated confectionary product comprises based on the total weight of the confectionary:

0.05 to 30% by weight of gelling agent,
0.1 to 15% by weight of water,
50% to 98% by weight of saccharide such as 65% to 80% by weight of sucrose and/or 15% to 30% by weight of glucose powder,
and/or 15% to 75% by weight polydextrose.

In a further aspect, the aerated confectionary product comprises based on the total weight of the confectionary:

0.05 to 30% by weight of gelling agent,
0.1 to 15% by weight of water,
50% to 98% by weight of saccharide such as 65% to 80% by weight of sucrose and/or 15% to 30% by weight of glucose powder
and/or 15% to 75% by weight polydextrose, and
0.01-5% emulsifier.

In a further aspect, the aerated confectionary product comprises based on the total weight of the confectionary:

0.05 to 30% by weight of gelling agent,
0.1 to 15% by weight of water,
50% to 98% by weight of saccharide such as 65% to 80% by weight of sucrose and/or 15% to 30% by weight of glucose powder,
and/or 15% to 75% by weight polydextrose,
0.01-5% chemical leavening ingredients.

In a further aspect, the aerated confectionary product comprises based on the total weight of the confectionary:

0.05 to 30% by weight of gelling agent,
0.1 to 15% by weight of water,
50% to 98% by weight of saccharide such as 65% to 80% by weight of sucrose and/or 15% to 30% by weight of glucose powder,
and/or 15% to 75% by weight polydextrose, and
0.01-5% fortifying ingredients.

In a further aspect, the aerated confectionary product comprises based on the total weight of the confectionary:

0.05 to 30% by weight of gelling agent,
0.1 to 15% by weight of water,
50% to 98% by weight of saccharide such as 65% to 80% by weight of sucrose and/or 15% to 30% by weight of glucose powder,
and/or 15% to 75% by weight polydextrose, and
0.01-5% heat sensitive ingredients.

### Process

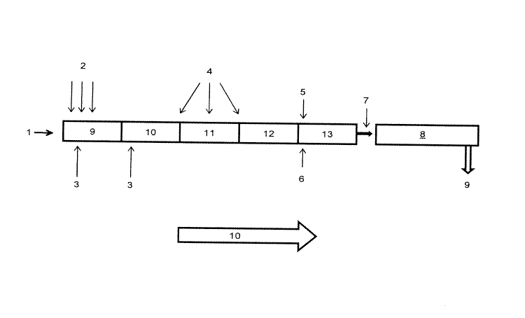

As a point of reference, FIG. 1 provides a schematic flow diagram of a simplified method for preparing an aerated product such as marbits, it being understood that a number of variations to the method shown in FIG. 1 can be employed and are well known in the art.

In one aspect, there is disclosed herein a method for producing an aerated product in a continuous process in which ingredients are mixed by use of an extruder with at least one screw-mixer extending in a feed direction through a mixing chamber having at least one port for adding ingredients and optionally at least one inlet for adding pressurized gas, the at least one port and the optionally at least one inlet being arranged successively along the screw-mixer in the feed direction, the method comprising the steps of:

adding dry content ingredient(s) and wet content ingredient(s) to the at least one port,
mixing the dry and wet content ingredient(s) by operation of the extruder to obtain a mixture,
heating the mixture in the extruder,
optionally cooling the heated mixture,
aerating the ingredients by adding a gas to an at least one inlet or by adding ingredients that generates a gas to the at least one port, and
extruding the mixture through a die.

In one aspect, there is disclosed herein a method for producing an aerated product in a continuous process in which ingredients are mixed by use of an extruder with at least one screw-mixer extending in a feed direction through a mixing chamber having at least one port for adding ingredients and at least one inlet for adding pressurized gas, the at least one port and the at least one inlet being arranged successively along the screw-mixer in the feed direction, the method comprising the steps of:

adding dry content ingredient(s) and wet content ingredient(s) to the at least one port,
mixing the dry and wet content ingredients by operation of the extruder to obtain a mixture,
heating the mixture in the extruder,
optionally cooling the heated mixture,
adding a pressurized gas to the heated mixture by an at least one inlet, and
extruding the mixture through a die.

In a further aspect, the extruder is a twin screw extruder. The two screws may be co-rotating or counter-rotating, intermeshing or non-intermeshing. In addition, the configurations of the screws themselves may be varied using forward conveying elements, reverse conveying elements, kneading blocks, and other designs in order to achieve particular mixing characteristics. In one aspect, the twin screw extruder uses forward conveying elements.

In one aspect, the extruder has at least a first and a second port, the second of the ports being arranged after the first port in the feeding direction.

Depending on the particular aerated product to be prepared it might be convenient to use several ports for adding the respectively the wet content and the dry content ingredients. In one aspect, the process comprise adding the dry content ingredient(s) to a first of the at least one ports, and adding the wet content ingredient(s) to a second of the at least one ports, the second of the ports being arranged after the first of the at least one ports in the feeding direction. In a further aspect, the dry content ingredient(s) is added to the first port, and the wet content ingredient(s) is added to the second port and the ingredient(s) are mixed by operation of the extruder. In a further aspect, the wet content ingredient(s) is added partly to the second port and partly to a third port.

In another aspect, the dry content ingredient(s) is added to a first of the at least one port, part of the wet content ingredient(s) to a second of the at least one ports, and the remaining part of the wet content ingredient(s) is added to a third of the at least one port. In one aspect, heat sensitive ingredients are suitably added after mixing, heating and cooling of the mixture.

In one aspect, the wet content ingredient(s) have been heated before addition to the extruder to a temperature of 30-100°, preferably 50-90° C. and most preferably 60-80° C.

In the section of the extruder where the addition of dry content ingredient(s) is taking place the temperature is suitably 0-100° C., preferably 10-80° C., more preferably 20-40° C.

When the ingredients have been combined they are entering a heating and mixing zone in which they are heated to a temperature of 50-200° C. Thus in one aspect, the mixture of dry content ingredient(s) and wet content ingredient(s) is mixed and heated to 50-200° C. before aeration. In a further aspect, the mixture of dry content ingredient(s) and wet content ingredient(s) is mixed and heated to 100-150° C. before aeration. In a further aspect, the mixture is heated to 115-130° C. before aeration.

The length of the heating and mixing zone and the screw speed is adjusted in order for the product to be heated and mixed to obtain a homogenous/melted mixture.

In one aspect, the herein described method may further comprise an optional cooling step after having obtained a homogenous and melted mixture. The mixture is suitably cooled to a temperature of −20-200° C., preferably 10-150° C., more preferably 10-100° C., most preferably 25-70° C. before aeration. In one aspect, heat sensitive ingredients are suitably added to the extruder after the mixture has been cooled.

As a further step, the product is aerated. This may be performed by the use of pressurized gas such as nitrogen and/or air. The injection points are chosen to achieve a good mixing of the gas into the product inside the extruder without having a negative influence on the production process. In one aspect, the pressurized gas is added after cooling of the mixture. In one aspect, the mixture is cooled to 70-115° C. before aeration. In another aspect, the mixture is cooled to 25-70° C. before aeration.

In another aspect, the aeration can be made by be incorporating ingredients such as chemical leavening ingredients that generates a gas during the process. Examples on such ingredients can be sodium bicarbonate and calcium carbonate.

The products can be made in various sizes and shapes by the choice of extruder setup. In one aspect, the die has an aperture of 1-1000 mm2, for smaller sized products preferably 1-50 mm2, for medium sized product preferably 50-500 mm2, for larger products preferably 500 mm2 and above. In a production embodiment the production capacity can be adjusted by the number of dies employed into the extruder exit.

By controlling the temperature of the die texture and surface of the finished product can be controlled. In one aspect, the die temperature is adjusted to −20-200° C., preferably 0-150° C., more preferably 10-100° C., most preferably 25-70° C.

The present methods can further comprise the step of forming, drying and/or cutting the cooled aerated product into pieces of desired shape, size and moisture content.

The temperature profile along the length of the extruder depends on the aerated products to be produced and the texture to be obtained. One example is a marbit-like product that is produced with the following temperature profile:

| | | | | | |
|---|---|---|---|---|---|
| Temp. | 40° C. | 120-125° C. | 120-125° C. | 120-125° C. | 60-90° C. |

As described above, FIG. 1 provides a schematic flow diagram showing a preferred embodiment of preparing an aerated product such as marbits, it being understood that a number of variations to the method shown in FIG. 1 can be employed and are well known in the art. Equipment suitable for practising the invention is commercial available. An example is a Clextral BC 45, twin-screw extruder with 5 barrels. In FIG. 1 an extruder 1 is shown which has 5 barrels. In one embodiment a twin-screw is extending in a feed direction 10 through a mixing chamber 9 having a port 2 for adding dry content ingredient(s) such as sucrose, glucose syrup powder, polydextrose, CMC and other powdered ingredients. The dry content ingredient(s) may be pre-mixed or added separately for example by a volumetric feeding system such as a K-Tron volumetric feeder. In one embodiment, the extruder has a port 3 for adding wet content ingredient(s) for example by a piston pump such as by a Watson Marlow peristaltic pump. Examples of wet content ingredient(s) are gelatine and/or PGE dissolved in water. The temperature in section 9 may suitably be 40° C. Depending on the aerated product prepared it may be suitably to add a part of the wet content ingredient(s) in a later section such as in section 10 in a port 3 for adding wet content ingredients. The temperature in section 10 may suitably be for example 120-125° C. In section 11 and 12 the temperature may suitably be 120-125° C. In section 11 and 12 the mixture is heated and conveyed before being cooled in section 13 to a temperature of for example 60-90° C. Heat-sensitive ingredients such as vitamins, minerals, cultures, enzymes, antioxidants, and/or phytosterols may suitably be added in port 5 in section 13 after the mixture has been cooled. Pressurized gas is suitably added in port 6 to obtain a good mixing of the gas into the aerated product. After the aerated product has left the extruder through a die resulting in marbit robe, the robe is cut and/or shaped.

The invention also relates to the following numbered embodiments:

Embodiment 1. A method for producing an aerated product in a continuous process in which ingredients are mixed by use of an extruder with at least one screw-mixer extending in a feed direction through a mixing chamber having at least one port for adding ingredients and optionally at least one inlet for adding pressurized gas, the at least one port and the optionally at least one inlet being arranged successively along the screw-mixer in the feed direction, the method comprising the steps of:
adding dry content ingredient(s) and wet content ingredient(s) to the at east one port,
mixing the dry and wet content ingredient(s) by operation of the extruder to obtain a mixture,
heating the mixture in the extruder,
optionally cooling the heated mixture,
aerating the ingredients by adding a gas to an at least one inlet or by adding ingredients that generates a gas to the at least one port, and
extruding the mixture through a die.
Embodiment 2. A method for producing an aerated product in a continuous process in which ingredients are mixed by use of an extruder with at least one screw-mixer extending in a feed direction through a mixing chamber having at least one port for adding ingredients and at least one inlet for adding pressurized gas, the at least one port and the at least one inlet being arranged successively along the screw-mixer in the feed direction, the method comprising the steps of:
adding dry content ingredient(s) and wet content ingredient(s) to the at least one port,
mixing the dry and wet content ingredient(s) by operation of the extruder to obtain a mixture,
heating the mixture in the extruder,
optionally cooling the heated mixture,
adding a pressurised gas to the mixture by an at least one inlet, and
extruding the mixture through a die.
Embodiment 3. The method according to any one of embodiments 1-2, wherein the extruder is a twin screw extruder.
Embodiment 4. The method according to any one of embodiments 1-3, wherein the extruder has at least a first and a second port, the second of the ports being arranged after the first port in the feeding direction.
Embodiment 5. The method according to any one of embodiments 1-4, wherein the dry content ingredient(s) is added to a first port, and the wet content ingredient(s) is added to a second port and the ingredient(s) are mixed by operation of the extruder.
Embodiment 6. The method according to embodiment 5, wherein the wet content ingredient(s) is added partly to the second port and partly to a third port.
Embodiment 7. The method according to any one of embodiments 1-6, wherein the mixture of dry content ingredient(s) and wet content ingredient(s) is mixed and heated to 50-200° C. before aeration.
Embodiment 8. The method according to embodiment 7, wherein the mixture of dry content ingredient(s) and wet content ingredient(s) is mixed and heated to 100-150° C. before aeration.
Embodiment 9. The method according to embodiment 8, wherein the mixture is heated to 115-130° C. before aeration.
Embodiment 10. The method according to any one of embodiments 1-9, wherein the mixture is cooled to 70-115° C. before aeration.
Embodiment 11. The method according to embodiment 10, wherein the mixture is cooled to 25-70° C. before aeration.
Embodiment 12. The method according to any one of embodiments 1-11, wherein heat sensitive ingredient(s) is added to the extruder after cooling.
Embodiment 13. The method according to any one of embodiments 1-12, wherein the pressurized gas is added after cooling.
Embodiment 14. The method according to any one of embodiments 1-13, wherein the pressurized gas is nitrogen and/or air.
Embodiment 15. The method according to any one of embodiments 1-14, wherein the die is temperature controlled to 25-70° C.
Embodiment 16. The method according to any one of embodiments 1-15, wherein the dry content ingredient(s) comprises a sweetening agent.
Embodiment 17. The method according to embodiment 16, wherein the sweetening agent comprises a saccharide component.
Embodiment 18. The method according to embodiment 17, wherein the saccharide component comprises sucrose powder.
Embodiment 19. The method according to embodiment 17, wherein the saccharide component comprises glucose syrup powder.
Embodiment 20. The method according to any one of embodiments 1-19, wherein the dry content ingredient(s) comprises a bulking agent.
Embodiment 21. The method according to embodiment 20, wherein the bulking agent comprises polydextrose, hydrogenated polydextrose or mixtures thereof.
Embodiment 22. The method according to any one of embodiments 1-21, wherein the wet content ingredient(s) comprises water.
Embodiment 23. The method according to embodiment 22, wherein the wet content ingredient(s) further comprises a gelling agent.
Embodiment 24. The method according to embodiment 23, wherein the gelling agent is a hydrocolloid ingredient.
Embodiment 25. The method according to embodiment 23, wherein the hydrocolloid ingredient is selected from gelatine, pectin, carrageenan, alginate, CMC, MCC, modified starches, albumen, gums and mixtures thereof.
Embodiment 26. The method according to embodiment 24, wherein the hydrocolloid ingredient comprises gelatine selected from bovine, pork, and/or piscine gelatine.
Embodiment 27. The method according to any one of embodiments 1-26, wherein the amount of wet content ingredient(s) is adjusted such that moisture content in the aerated product is about 0.1 to 30%, 0.5 to 15%, 0.5 to 10%, 1 to 8%, 1 to 6%, 1 to 4%, 2 to 4%, or 1 to 3% by weight final moisture content.
Embodiment 28. The method according to any one of embodiments 1-27, wherein the aerated product is a aerated confectionery product, a cereal bar or a nutritional snack.
Embodiment 29. The method according to embodiment 28, wherein the aerated confectionery product is marbit rope.
Embodiment 30. The method according to any one of embodiments 1-29, wherein the aerated product comprises an emulsifier.
Embodiment 31. The method according to any one of embodiments 1-30, wherein the product is aerated by adding ingredients that generates a gas.
Embodiment 32. The method according to any one of embodiments 1-31, wherein the aerated product comprises heat sensitive ingredients.
Embodiment 33. The method according to any one of embodiments 1-32, wherein the aerated product comprises fortifying ingredients.
Embodiment 34. The method according to any one of embodiments 1-33, wherein the aerated product comprises moisture in an amount of 0.1 to 15% by weight.
Embodiment 35. The method according to any one of embodiments 1-34, wherein the aerated product comprises moisture in an amount of 0.5 to 15%, 0.5 to 10%, 0.8 to 8%, 1.0 to 6%, 1.2 to 5%, 1.3 to 5%, 1.4-4.5% or 1.5 to 4% by weight.
Embodiment 36. The method according to any one of embodiments 1-36, wherein the amount of moisture added is 0.5 to 15%, 0.5 to 10%, 0.8 to 8%, 1.0 to 6%, 1.2 to 5%, 1.3 to 5%, 1.4-4.5% or 1.5 to 4% by weight of ingredients added to the extruder.
Embodiment 37. The method according to any one of embodiments 1-36, wherein the wet content ingredient(s) comprises a gelling agent.
Embodiment 38. The method according to any one of embodiments 1-37, wherein the saccharide component is used in an amount of 70% to 90% by weight of the aerated product.
Embodiment 39. The method according to embodiment 38, wherein the saccharide component comprises sucrose powder and/or glucose syrup powder.
Embodiment 40. The method according to any one of embodiments 1-39, wherein the dry content ingredient(s) comprises a bulking agent such as polydextrose, hydrogenated polydextrose or mixtures thereof.
Embodiment 41. The method according to any one of embodiments 1-40, wherein the aerated product comprises an emulsifier.
Embodiment 42. The method according to any one of embodiments 1-41, wherein the aerated product is a marbit robe.

### Example 1

A mixture of 75% sucrose (Nordzucker, Braunschweig, Germany) and 25% dehydrated glucose syrup 47 DE (Roquette Freres, Lestrem, France) was fed by the extruder screw feeder at a rate of 40 kg/h into the first barrel of an extruder (BC 45 twin-screw, co-rotating extruder, L/D ratio 23, Clextral, Firminy, France). Screw speed was 200 rpm. Screw configuration and temperature was:

| | Type | | | | | | | | | | | | | | |
|---|---|---|---|---|---|---|---|---|---|---|---|---|---|---|---|
| | 2F | 2F | 2F | 2F | BL2 | BL2 | 2F | 2F | BL2 | 2F | 2F | BL2 | 2F | 2F | 2F |
| Pitch, | 66 | 50 | 50 | 33 | 45°+ | 90° | 50 | 33 | 90° | 33 | 33 | 90° | 33 | 33 | 25 |
| mm | | | | | | | | | | | | | | | |
| Length, | 200 | 200 | 50 | 50 | 50/ | 50/ | 100 | 100 | 50/ | 100 | 50 | 50/ | 50 | 50 | 100 |
| mm | | | | | | | | | | | | | | | |

| | | | | | |
|---|---|---|---|---|---|
| Section | 9 | 10 | 11 | 12 | 13 |
| of the | | | | | |
| Extruder | | | | | |
| (see | | | | | |
| FIG. 1) | | | | | |
| Temp. | 40° C. | 120-125° C. | 120-125° C. | 120-125° C. | 50-60° C. |

2F: twin flight
BL2: a mixing element
Pitch is the length in mm between two “turns” in the screw element (between two “tops”)

A mixture of 50% Gelatine 220 Bloom (Gelita, Eberbach, Germany) and 50% tap water was mixed and pre-heated to 60° C. in a heating cabinet (Binder, Tuttingen, Germany) for 16 hours. Before use the gelatine/water mixture was kept in a double jacketed hopper heated to 85° C. by water tracing (Julabo, Seelbach, Germany) and was fed by a mono pump (Netzsch, Waldkreiburg, Germany) at a rate of 2.4 kg/h into section 10 of the extruder (see FIG. 1).

An airflow of 0.2 L/s (Hedland Flowmeter, Racine, Wis., USA) was fed through a 1 mm 0 nozzle into section 12 of the extruder (see FIG. 1) The die plate was temperature controlled by internal liquid circulation to 50° C. (Single, Hochdorf, Germany) and the mass was extruded through 2 openings 4 mm Ø.

The product was collected on a conveyer. No further treatment was needed to produce a continuous rope of product.

An indication of extrudate density was obtained by collecting extrudate directly from the die into a 1 L metal beaker. Product density was kept in the range of 0.4-0.5 g/ccm.

### Example 2

A mixture of 75% sucrose (Nordzucker, Braunschweig, Germany) and 25% polydextrose (Litesse® Ultra, Danisco, Copenhagen, Denmark) was fed by the extruder screw feeder at a rate of 40 kg/h into the first barrel of an extruder (BC 45 twin-screw, co-rotating extruder, L/D ratio 23, Clextra), Firminy, France). Screw speed was 200 rpm. Screw configuration and temperature was:

| | Type | | | | | | | | | | | | | | |
|---|---|---|---|---|---|---|---|---|---|---|---|---|---|---|---|
| | 2F | 2F | 2F | 2F | BL2 | BL2 | 2F | 2F | BL2 | 2F | 2F | BL2 | 2F | 2F | 2F |
| Pitch, | 66 | 50 | 50 | 33 | 45°+ | 90° | 50 | 33 | 90° | 33 | 33 | 90° | 33 | 33 | 25 |
| mm | | | | | | | | | | | | | | | |
| Length, | 200 | 200 | 50 | 50 | 50/ | 50/ | 100 | 100 | 50/ | 100 | 50 | 50/ | 50 | 50 | 100 |
| mm | | | | | | | | | | | | | | | |

| | | | | | |
|---|---|---|---|---|---|
| Section | 9 | 10 | 11 | 12 | 13 |
| of the | | | | | |
| Extruder | | | | | |
| (see | | | | | |
| FIG. 1) | | | | | |
| Temp. | 40° C. | 120-125° C. | 120-125° C. | 120-125° C. | 50-60° C. |

2F: twin flight
BL2: a mixing element
Pitch is the length in mm between two “turns” in the screw element (between two “tops”)

A mixture of 50% Gelatine 220 Bloom (Gelita, Eberbach, Germany) and 5096 tap water was mixed and pre-heated to 60° C. in a heating cabinet (Binder, Tuttingen, Germany) for 16 hours. Before use the gelatine/water mixture was kept in a double jacketed hopper heated to 85° C. by water tracing (Julabo, Seelbach, Germany) and was fed by a monopump (Netzsch, Waldkreiburg, Germany) at a rate of 2.4 kg/h into section 10 of the extruder (see FIG. 1).

An airflow of 0.2 L/s (Hedland Flowmeter, Racine, Wis., USA) was fed through a 1 mm 0 nozzle into section 12 of the extruder (see FIG. 1) The die plate was temperature controlled by internal liquid circulation to 50° C. (Single, Hochdorf, Germany) and the mass was extruded through 2 openings 4 mm Ø.

Product was collected on a conveyer. No further treatment was needed to produce a continuous rope of product.

### Example 3

A mixture of 74% sucrose (Nordzucker, Braunschweig, Germany), 25% dehydrated glucose syrup 47 DE (Roquette Freres, Lestrem, France) and 1% Carboxymethyl Cellulose (Danisco, Copenhagen, Denmark) was fed by the extruder screw feeder at a rate of 40 kg/h into the first barrel of an extruder (BC 45 twin-screw, co-rotating extruder, L/D ratio 23, Clextral, Firminy, France). Screw speed was 200 rpm. Screw configuration and temperature was:

| | Type | | | | | | | | | | | | | | |
|---|---|---|---|---|---|---|---|---|---|---|---|---|---|---|---|
| | 2F | 2F | 2F | 2F | BL2 | BL2 | 2F | 2F | BL2 | 2F | 2F | BL2 | 2F | 2F | 2F |
| Pitch, | 66 | 50 | 50 | 33 | 45°+ | 90° | 50 | 33 | 90° | 33 | 33 | 90° | 33 | 33 | 25 |
| mm | | | | | | | | | | | | | | | |
| Length, | 200 | 200 | 50 | 50 | 50/ | 50/ | 100 | 100 | 50/ | 100 | 50 | 50/ | 50 | 50 | 100 |
| mm | | | | | | | | | | | | | | | |

| | | | | | |
|---|---|---|---|---|---|
| Section | 9 | 10 | 11 | 12 | 13 |
| of the | | | | | |
| Extruder | | | | | |
| (see | | | | | |
| FIG. 1) | | | | | |
| Temp. | 40° C. | 120-125° C. | 120-125° C. | 120-125° C. | 50-60° C. |

2F: twin flight
BL2: a mixing element
Pitch is the length in mm between two “turns” in the screw element (between two “tops”)

A mixture of 50% Gelatine 220 Bloom (Gelita, Eberbach, Germany) and 50% tap water was mixed and pre-heated to 60° C. in a heating cabinet (Binder, Tuttingen, Germany) for 16 hours. Before use the gelatine/water mixture was kept in a double jacketed hopper heated to 85° C. by water tracing (Julabo, Seelbach, Germany) and was fed by a monopump (Netzsch, Waldkreiburg, Germany) at a rate of 2.4 kg/h into section 10 of the extruder (see FIG. 1).

An airflow of 0.2 L/s (Hedland Flowmeter, Racine, Wis., USA) was fed through a 1 mm 0 nozzle into section 12 of the extruder (see FIG. 1) The die plate was temperature controlled by internal liquid circulation to 50° C. (Single, Hochdorf, Germany) and the mass was extruded through 2 openings 4 mm Ø.

Product was collected on a conveyer. No further treatment was needed to produce a continuous rope of product.

### Example 4

A mixture of 75% sucrose (Nordzucker, Braunschweig, Germany) and 25% polydextrose (Litesse® Ultra, Danisco, Copenhagen, Denmark) was fed by the extruder screw feeder at a rate of 40 kg/h into the first barrel of an extruder (BC 45 twin-screw, co-rotating extruder, L/D ratio 23, Clextral, Firminy, France). Screw speed was 200 rpm. Screw configuration and temperature was:

| | Type | | | | | | | | | | | | | | |
|---|---|---|---|---|---|---|---|---|---|---|---|---|---|---|---|
| | 2F | 2F | 2F | 2F | BL2 | BL2 | 2F | 2F | BL2 | 2F | 2F | BL2 | 2F | 2F | 2F |
| Pitch, | 66 | 50 | 50 | 33 | 45°+ | 90° | 50 | 33 | 90° | 33 | 33 | 90° | 33 | 33 | 25 |
| mm | | | | | | | | | | | | | | | |
| Length, | 200 | 200 | 50 | 50 | 50/ | 50/ | 100 | 100 | 50/ | 100 | 50 | 50/ | 50 | 50 | 100 |
| mm | | | | | | | | | | | | | | | |

| | | | | | |
|---|---|---|---|---|---|
| Section | 9 | 10 | 11 | 12 | 13 |
| of the | | | | | |
| Extruder | | | | | |
| (see | | | | | |
| FIG. 1) | | | | | |
| Temp. | 40° C. | 120-125° C. | 120-125° C. | 120-125° C. | 50-60° C. |

2F: twin flight
BL2: a mixing element
Pitch is the length in mm between two “turns” in the screw element (between two “tops”)

Polyglycerol Ester (GRINDSTED® PGE, Danisco, Copenhagen, Denmark) and tap water was mixed at a ratio of 1:9 and was fed into the first barrel of the same extruder by the extruders piston pump at a rate of 0.8 kg/h.

An airflow of 0.2 L/s (Hedland Flowmeter, Racine, Wis., USA) was fed through a 1 mm 0 nozzle into section 12 of the extruder (see FIG. 1) The die plate was temperature controlled by internal liquid circulation to 50° C. (Single, Hochdorf, Germany) and the mass was extruded through 2 openings 4 mm Ø.

Product was collected on a conveyer. No further treatment was needed to produce a continuous rope of product.

### Example 5

A mixture of 75% sucrose (Nordzucker, Braunschweig, Germany) and 25% polydextrose (Litesse® Ultra, Danisco, Copenhagen, Denmark) was fed by the extruder screw feeder at a rate of 40 kg/h into the first barrel of an extruder (BC 45 twin-screw, co-rotating extruder, L/D ratio 23, Clextral, Firminy, France). Screw speed was 200 rpm. Screw configuration and temperature was:

| | Type | | | | | | | | | | | | | | |
|---|---|---|---|---|---|---|---|---|---|---|---|---|---|---|---|
| | 2F | 2F | 2F | 2F | BL2 | BL2 | 2F | 2F | BL2 | 2F | 2F | BL2 | 2F | 2F | 2F |
| Pitch, | 66 | 50 | 50 | 33 | 45°+ | 90° | 50 | 33 | 90° | 33 | 33 | 90° | 33 | 33 | 25 |
| mm | | | | | | | | | | | | | | | |
| Length, | 200 | 200 | 50 | 50 | 50/ | 50/ | 100 | 100 | 50/ | 100 | 50 | 50/ | 50 | 50 | 100 |
| mm | | | | | | | | | | | | | | | |

| | | | | | |
|---|---|---|---|---|---|
| Section | 9 | 10 | 11 | 12 | 13 |
| of the | | | | | |
| Extruder | | | | | |
| (see | | | | | |
| FIG. 1) | | | | | |
| Temp. | 140° C. | 120-125° C. | 120-125° C. | 120-125° C. | 50-60° C. |

2F: twin flight
BL2: a mixing element
Pitch is the length in mm between two “turns” in the screw element (between two “tops”)

Sorbitan Monostearate (GRINDSTED® SMS, Danisco, Copenhagen, Denmark) was fed into the first barrel of the same extruder at a rate of 0.4 kg/h by a volumetric feeder (K-Tron Process Group, Pitman, N.J., USA).

Water was fed into the first barrel of the same extruder by the extruders piston pump at a rate of 0.6 kg/h.

An airflow of 0.2 L/s (Hedland Flowmeter, Racine, Wis., USA) was fed through a 1 mm 0 nozzle into section 12 of the extruder (see FIG. 1) The die plate was temperature controlled by internal liquid circulation to 50° C. (Single, Hochdorf, Germany) and the mass was extruded through 2 openings 4 mm Ø.

Product was collected on a conveyer. No further treatment was needed to produce a continuous rope of product.

### Example 6

A mixture of 75% sucrose (Nordzucker, Braunschweig, Germany) and 25% polydextrose (Litesse® Ultra, Danisco, Copenhagen, Denmark) was fed by the extruder screw feeder at a rate of 40 kg/h into the first barrel of an extruder (BC 45 twin-screw, co-rotating extruder, L/D ratio 23, Clextral, Firminy, France). Screw speed was 200 rpm. Screw configuration and temperature was:

| | Type | | | | | | | | | | | | | | |
|---|---|---|---|---|---|---|---|---|---|---|---|---|---|---|---|
| | 2F | 2F | 2F | 2F | BL2 | BL2 | 2F | 2F | BL2 | 2F | 2F | BL2 | 2F | 2F | 2F |
| Pitch, | 66 | 50 | 50 | 33 | 45°+ | 90° | 50 | 33 | 90° | 33 | 33 | 90° | 33 | 33 | 25 |
| mm | | | | | | | | | | | | | | | |
| Length, | 200 | 200 | 50 | 50 | 50/ | 50/ | 100 | 100 | 50/ | 100 | 50 | 50/ | 50 | 50 | 100 |
| mm | | | | | | | | | | | | | | | |

| | | | | | |
|---|---|---|---|---|---|
| Section | 9 | 10 | 11 | 12 | 13 |
| of the | | | | | |
| Extruder | | | | | |
| (see | | | | | |
| FIG. 1) | | | | | |
| Temp. | 40° C. | 120-125° C. | 120-125° C. | 120-125° C. | 50-60° C. |

2F: twin flight
BL2: a mixing element
Pitch is the length in mm between two “turns” in the screw element (between two “tops”)

A mixture of 20% Carrageenan (GRINDSTED® Carrageenan CS 199, Danisco, Copenhagen, Denmark) and 80% tap water was mixed and pre-heated to ˜90° C. in a water bath and was kept in a double jacketed hopper heated to 90° C. by water tracing (Julabo, Seelbach, Germany) and was fed by a mono pump (Netzsch, Waldkreiburg, Germany) at a rate of 1.5 kg/h into section 10 of the extruder (see FIG. 1).

An airflow of 0.2 L/s (Hedland Flowmeter, Racine, Wis., USA) was fed through a 1 mm 0 nozzle into section 12 of the extruder (see FIG. 1). The die plate was temperature controlled by internal liquid circulation to 50° C. (Single, Hochdorf, Germany) and the mass was extruded through 2 openings 4 mm Ø.

Product was collected on a conveyer. No further treatment was needed to produce a continuous rope of product.

All patents, patent applications, and published references cited herein are hereby incorporated by reference in their entirety. The disclosure set forth herein has been particularly shown and described with references to preferred embodiments thereof, it will be understood by those skilled in the art that various changes in form and details may be made therein without departing from the scope encompassed by the present disclosure.

1. A method for producing an aerated product in a continuous process in which ingredients are mixed by use of an extruder with at least one screw-mixer extending in a feed direction through a mixing chamber having at least one port for adding ingredients and optionally at least one inlet for adding pressurized gas, the at least one port and the optionally at least one inlet being arranged successively along the screw-mixer in the feed direction, the method comprising the steps of:
adding dry content ingredient(s) and wet content ingredient(s) to the at least one port,
mixing the dry and wet content ingredient(s) by operation of the extruder to obtain a mixture,
heating the mixture in the extruder,
optionally cooling the heated mixture,
aerating the ingredients by adding a gas to an at least one inlet or by adding ingredients that generates a gas to the at least one port, and
extruding the mixture through a die,
wherein the aerated product comprises moisture in an amount of 0.1 to 15% by weight.

2. The method according to claim 1, wherein the extruder has at least one inlet for adding pressurized gas.

3. The method according to claim 2, wherein the ingredients are aerated by adding a pressurised gas to the mixture by the at least one inlet.

4. The method according to any one of claims 1-3, wherein the extruder is a twin screw extruder.

5. The method according to any one of claims 1-4, wherein the extruder has at least a first and a second port, the second of the ports being arranged after the first port in the feeding direction.

6. The method according to any one of claims 1-5, wherein the aerated product comprises moisture in an amount of 0.5 to 15%, 0.5 to 10%, 0.8 to 8%, 1.0 to 6%, 1.2 to 5%, 1.3 to 5%, 1.4-4.5% or 1.5 to 4% by weight.

7. The method according to any one of claims 1-6, wherein the amount of moisture added is 0.5 to 15%, 0.5 to 10%, 0.8 to 8%, 1.0 to 6%, 1.2 to 5%, 1.3 to 5%, 1.4-4.5% or 1.5 to 4% by weight of ingredients added to the extruder.

8. The method according to any one of claims 1-7, wherein the wet content ingredient(s) comprises a gelling agent.

9. The method according to any one of claims 1-8, wherein the wet content ingredient(s) comprises water.

10. The method according to any one of claims 1-9, wherein the dry content ingredient(s) comprises a sweetening agent such as a saccharide component.

11. The method according to claim 10, wherein the saccharide component is used in an amount of 70% to 90% by weight of the aerated product.

12. The method according to claim 11, wherein the saccharide component comprises sucrose powder and/or glucose syrup powder.

13. The method according to any one of claims 1-12, wherein the dry content ingredient(s) comprises a bulking agent such as polydextrose, hydrogenated polydextrose or mixtures thereof.

14. The method according to any one of claims 1-13, wherein the aerated product comprises an emulsifier.

15. The method according to any one of claims 1-14, wherein the dry content ingredient(s) is added to a first port and the wet content ingredient(s) is added to a second port, and the ingredient(s) are mixed by operation of the extruder.

16. The method according to any one of claims 1-15, wherein the dry content ingredient(s) and wet content ingredient(s) are mixed and heated at 50-200° C. before aeration.

17. The method according to any one of claims 1-16, wherein the mixture is cooled to 70-115° C. before aeration.

18. The method according to any one of claims 1-17, wherein heat sensitive ingredient(s) is added to the extruder after cooling.

19. The method according to any one of claims 1-18, wherein the pressurized gas is added after cooling.

20. The method according to any one of claims 1-19, wherein the aerated product is a marbit robe.
